(19) United States
(12) Patent Application Publication
(10) Pub. No.: US 2014/0129572 A1
(43) Pub. Date: May 8, 2014

(54) PLATFORM AND METHOD OF TAGGING RECREATIONAL LAND

(71) Applicant: Michael J. Bradsher, Pike Road, AL (US)

(72) Inventor: Michael J. Bradsher, Pike Road, AL (US)

(21) Appl. No.: 13/952,628

(22) Filed: Jul. 28, 2013

Related U.S. Application Data
(60) Provisional application No. 61/721,841, filed on Nov. 2, 2012.

(51) Int. Cl. G06F 17/30

(52) U.S. Cl. CPC G06F 17/30241
USPC 707/748

(57) ABSTRACT

A platform and method configured to allow individuals to list recreational land for sale with verified recreational data related to such recreational land. More specifically, the present invention is directed to a platform and method of tagging recreational land for sale with recreational activities including wildlife associated activities.

### CROSS REFERENCE TO RELATED APPLICATIONS

This U.S. utility patent application claims the benefit of U.S. Provisional patent application Ser. No. 61/721,841 filed Nov. 2, 2012 and U.S. patent application Ser. No. 13/896,960 filed May 17, 2013 which claims priority to U.S. Provisional Patent Application Ser. No. 61/648,253 filed May 17, 2012, U.S. Provisional Patent Application Ser. No. 61/678,833 filed Aug. 2, 2012 and U.S. Provisional Patent Application Ser. No. 61/692,886 filed Aug. 24, 2012, the entire disclosures of these applications being considered part of the disclosure of this application and hereby incorporated by reference.

### BACKGROUND OF THE INVENTION

1. Field of the Invention

The present application provides a platform and method configured to allow individuals to list recreational land for sale with verified recreational data related to such recreational land. More specifically, the present invention is directed to a platform and method of tagging recreational land for sale with recreational activities including wildlife associated activities.

2. Description of the Prior Art

Wildlife activities and other outdoor activities such as hunting, fishing, and wildlife watching account for a large sector of recreational spending around the globe. In the United States alone, one study estimated that one out of every one hundred dollars spent on all goods and services produced in the United States in 2011 was related to wildlife associated activities including hunting, fishing and wildlife watching. It is estimated by the United States Fish and Wildlife Service that in 2011 wildlife associated activities were enjoyed by roughly 90 million citizens or 38% of the population age 16 and older and in pursuit of such wildlife associated activities, these individuals spent an estimated $145 billion dollars in 2011. More specifically, the United States Fish and Wildlife Service estimated that in 2011, hunters spent $34 billion, anglers spent $41.8 billion and wildlife watchers spent $55 billion dollars. Every year outdoor enthusiasts visit recreational land with the hope of spotting or taking a trophy animal. For example, for hunters a large buck or a variety of different ducks or for anglers a fish of a certain size, the capture of a trophy animal represents a cherished high point for many outdoor enthusiasts. Similarly, bird-watching, chasing, and sightings of rare or unique birds and animals also represent accomplishments for various individuals involved in wildlife watching activities. While many outdoor enthusiasts participate in these wildlife associated activities on public land, a large portion of them participate in them on private recreational land.

For many outdoor enthusiasts, it is difficult to find recreational land on which the current owner allows the outdoor enthusiasts to pursue the desired wildlife associated activities. Therefore, many outdoor enthusiasts dream of the day that they may own or exclusively lease a choice piece of recreational land that supports their desired wildlife associated activities. One problem for many outdoor enthusiasts is determining what particular parcels of recreational land will support or enhance their desired wildlife associated activities. For example, a deer hunter may desire a piece of recreational land that is regularly visited by large bucks and is capable of supporting or providing passage to a large number of deer and has the desired habitat. While the outdoor enthusiast or hunter may have an idea of what features an ideal parcel of recreational land should include for their desired wildlife associated activity, currently there is no method, other than the representations of the seller or prior experience by the outdoor enthusiast on that particular parcel of recreational land, to determine what is a prime and desirable parcel of recreational land versus what is a mediocre or undesirable parcel of recreational land. As such, an outdoor enthusiast may purchase what is believed to be a prime parcel of recreational land only to find out that the recreational land has little to no capability of supporting the desired wildlife associated activities. Therefore, many outdoor enthusiasts never actually purchase recreational land or are often disappointed when they do purchase recreational land.

As many parcels of recreational land are located remote from population centers, it is also difficult to obtain accurate information before taking the effort to drive out and personally view the recreational land. There is currently no way for an outdoor enthusiast to determine that the description or pictures adequately show the complete parcel before spending the effort to view the parcel of recreational land in person.

### SUMMARY OF THE INVENTION

The present application provides a platform and method configured to allow individuals to list recreational land for sale with verified recreational data related to such recreational land. More specifically, the present invention is directed to a platform and method of tagging recreational land for sale with recreational activities including wildlife associated activities.

The method of displaying and ranking recreational land includes the steps of collecting input information regarding wildlife associated activities, uploading the collected input information into a database, and ranking parcels of land using the collected input information.

The collected input information includes location data, which may include at least one of address, GPS coordinates, and county and state. The method may be configured, such that the location data is not visible to users of the database until the recreational land is listed for sale. Of course, the location data may remain visible to the owner of the parcel, or the party who uploaded the information regarding the recreational land, such as an outdoorsman. Additionally, the location data may include information regarding at least one of property tax rates for the land, topographical information and geological information. Examples of topographical information included as part of the location data may include information regarding at least one of land cover, value of lumber, species of trees, proximity to water, natural food sources, slope of land, and elevation. These may be entered by the outdoorsman, landowner, or even obtained from public record databases and other private databases. Other examples of location data, related to the topographical information, may include geological information including soil and climate conditions or other geological features of the recreational land.

In addition, the location data may include information regarding proximate water features including at least one of type of water feature, water rights, clarity, weed growth, bottom depth, bottom composition, drop of stream or river, flow rates of stream or river and wetland features, or any other desirable features regarding proximate water features. While it is preferable that the water features be located on or adjoining the land, in some circumstances nearby water features not part of the recreational land may be included. The type of water feature is selected from at least one of stream, river, and lake.

The location data requested, displayed, or searched may change depending on the type of associated wildlife activity. In addition, some of the location data may vary depending on the determined actual location of the recreational land. As such, the step of obtaining additional location information from verified third party sources and public records, may search for different records or even different databases and sources depending on the recreational activity or location of the recreational land. Using information in the database and information from public records and third party sources, the method may include a step of prefilling certain location information during said step of collecting input information.

The step of collecting input information regarding wildlife associated activities may further include at least one type of wildlife associated activity and a time input related to the wildlife associated activity. The at least one type of wildlife associated activity may include at least one of hunting, fishing, and wildlife watching.

The step of collecting input information regarding wildlife associated activities may further include at least one of equipment data, physical animal data, and outdoor enthusiast identity data. If the at least one of equipment data, physical animal data, and outdoor enthusiast identity data is equipment data, the equipment data collected may depend on the type of wildlife associated activity. Therefore, only relevant questions are asked of the outdoor enthusiast. For example, if the type of wildlife activity is hunting, the equipment data may include at least one of the general classification of the weapon, manufacturer, model, type, caliber, type of ammunition, type of projectile, type of bait and type of attractant Likewise, if the wildlife associated activity is fishing, the equipment data may include at least one of type of tackle, bait, lure, line, rod, and reel information. Information about the rod may include length, manufacturer, type, thickness, and any other desirable information. If the wildlife associated activity is wildlife watching and the equipment data includes at least one of type of spotting scope, type of camera, power of spotting scope, camera lens information, filters, aperture, shutter speed, manufacturer of the equipment, model of equipment, ISO, and focal length. In addition, for all outdoor activities, it could include information relating to a guide service, name of lodge, name of camp, and name of facility used, that is proximate to or located on the recreational land.

If the at least one of equipment data, physical animal data, and outdoor enthusiast identity data is physical animal data, the physical animal data collected may be dependent on the type of wildlife associated activity, and display different questions and request different inputs. Examples of physical animal data includes species of wildlife, and at least one of a size characteristic of wildlife and a quality characteristic of wildlife.

The method may include a time input, such as at least one of year, month, hour, and minute at which wildlife was taken during a wildlife associated activity. The time input allows recreational land users to judge the value of the land for their desired activities, based on when they would be able to use the land.

The method may further include a step of displaying a ranked parcel of recreational land. The step of ranking may further include a step of generating a list of ranked recreational land. For example, ranked parcels of recreational land within a certain proximity distance are displayed in relation to specified wildlife associated activities. The method may include a step of ranking the recreational land based on at least one of lumber value, recreational value, physical animal data, and recreation activity. In addition, the method may further include a step of determining the likelihood of selected wildlife related activities for a parcel of recreational land.

The step of generating a list of ranked recreational land may include a step of comparing entries stored in the database for at least one portion of the data related to the recreational land to other recreational land parcels.

The step of ranking may also include the step of ranking through selected criteria, including at least one of a number of animals taken on a particular parcel of land, size of wildlife animals on a particular parcel of land, size of animals taken on a surrounding parcels, rare types of wildlife, property tax rates, and economic value of the parcel or surrounding parcels.

The step of collecting input information may include a step of certifying the information. The step of certifying the information includes a step of obtaining a visual recording. Similar to certifying the step of collecting the input information may include a step of data entering by a third party certifier.

The method may further including a step of displaying multiple lists of ranked recreational land according to different ranking schemes. The method may also include the steps of receiving a search query from a user and displaying a list of ranked recreational land. The search query is at least one of geographic area, specified activity, and specified wildlife.

The method may include a step of displaying a trophy room for each parcel of recreational land. The trophy room may be populated with all trophy animal entries related to the recreational land parcel in a specified period of time. For example, the trophy room may be populated with all trophy animal entries within a geographic area of the recreational land parcel in a specified period of time. The step of ranking may be based on the ranking of the trophy rooms and use the trophy rooms to generate a list of ranked recreational land. The land may be ranked in the step of ranking based on the animals on the recreational land, which includes in the water on or adjacent to the recreational land. In addition, the land may be ranked based on the resources available on the land, such as water rights, timber, minerals, and the like.

The method further includes a step of inputting into the database of parcels of land. The parcels of land may be drawn from tax ids, multiple listing services or other databases of land, such that information regarding each parcel of recreational land already exists in the database.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a block diagram flow chart illustrating the method for generating a database of certified trophy game animal information in accordance with an aspect of the subject invention.

FIG. 2 is a screenshot illustrating an exemplary electronic form used for collecting input information in accordance with an aspect of the subject invention.

FIG. 3 is a screenshot illustrating an exemplary webpage for searching and accessing the database generated in accordance with an aspect of the subject invention.

FIG. 4 is a screenshot illustrating an exemplary webpage showing the certified trophy animal entries taken and uploaded by a single individual in accordance with an aspect of the subject invention.

FIG. 5 is a screenshot illustrating an exemplary webpage showing a single certified trophy animal entry uploaded to the database in accordance with an aspect of the subject invention.

FIG. 6 is a screenshot illustrating an exemplary webpage for searching and accessing the database generated in accordance with an aspect of the subject invention.

FIG. 7 is a screenshot illustrating an exemplary webpage showing a single certified trophy animal entry uploaded to the database in accordance with an aspect of the subject invention.

FIG. 8 is a screenshot illustrating an exemplary webpage showing information concerning a certification partner in accordance with an aspect of the subject invention.

### DETAILED DESCRIPTION OF THE ENABLING EMBODIMENTS

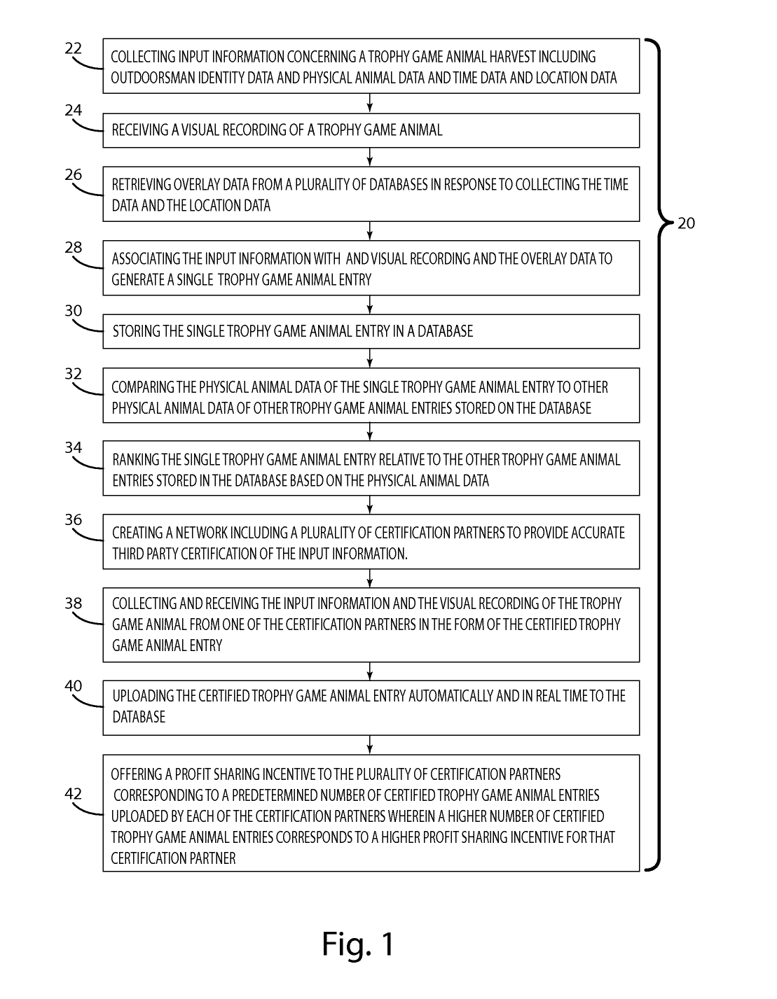

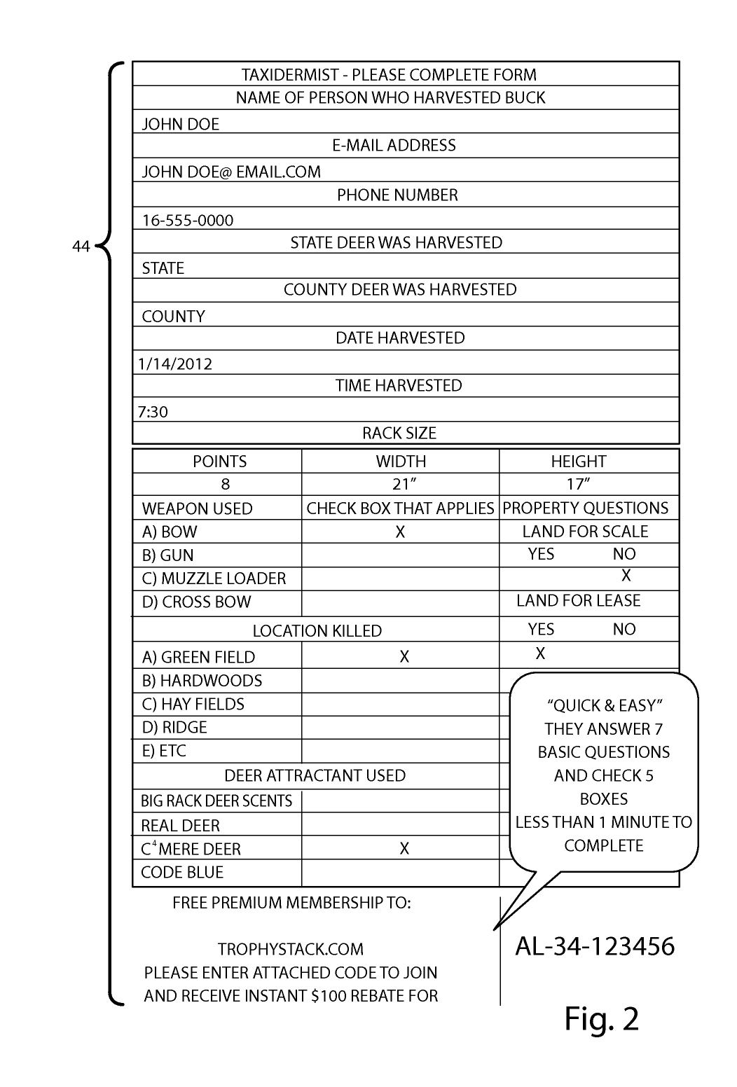

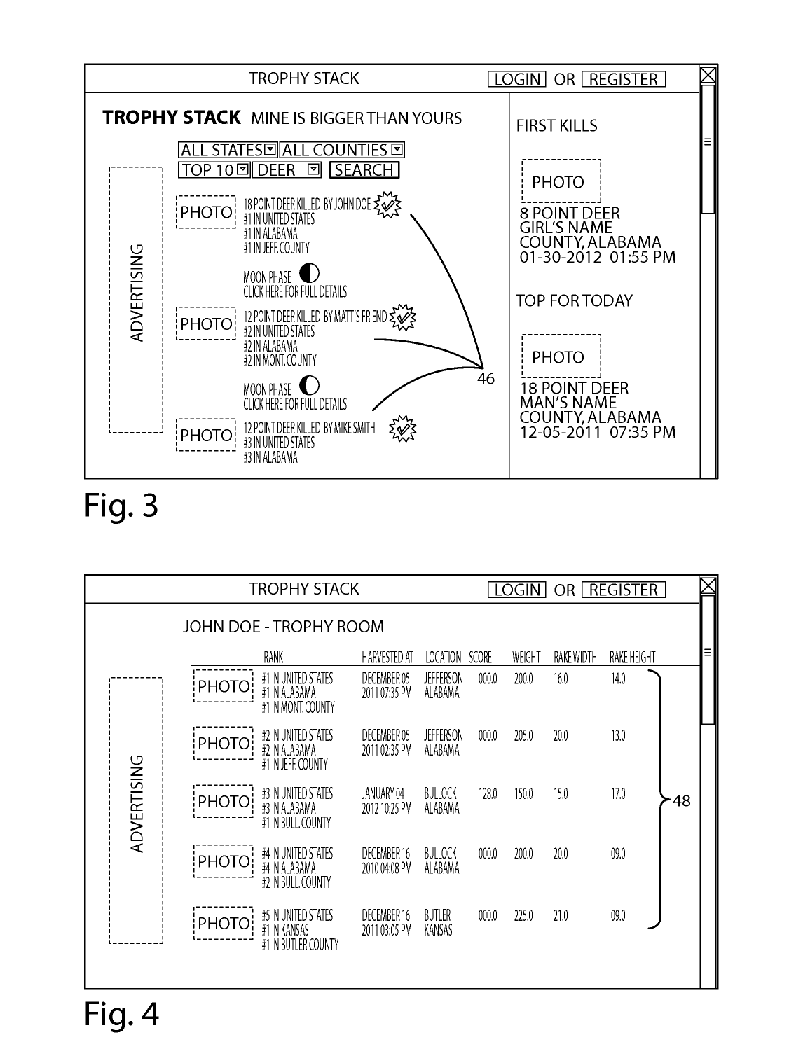

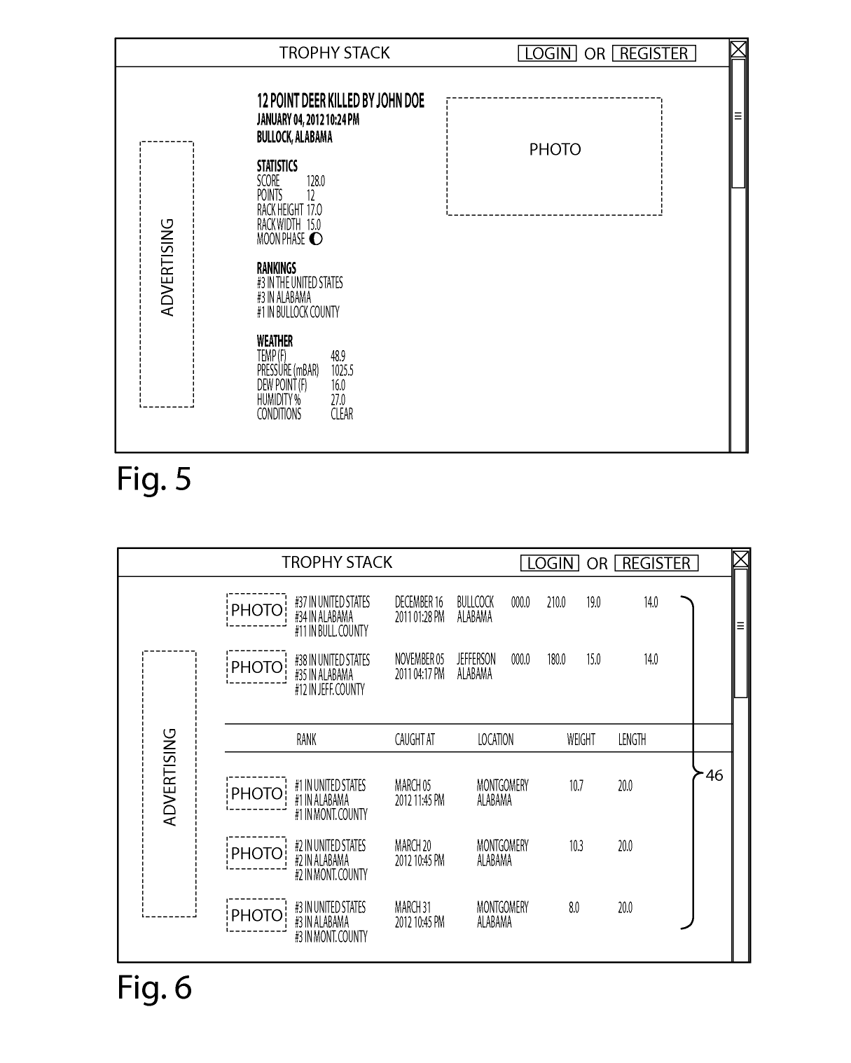

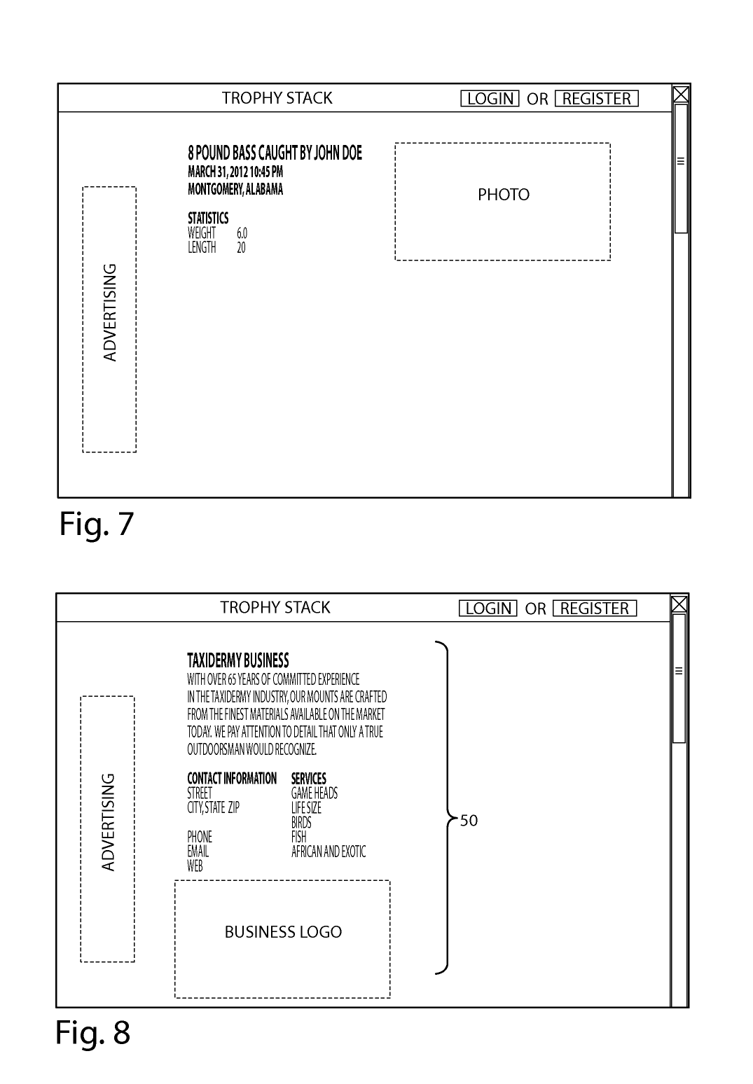

The present application provides a method and system for entering information regarding recreational land as part of providing information regarding trophy animals by outdoor enthusiasts and then ranking the recreational land using selected criteria. With the information uploaded by independent third parties, a seller may list recreational land that appears in the database in relation to wildlife associated activities. Therefore, a purchaser of the recreational land may see the history of wildlife associated activities that have been historically performed on the recreational land without generally relying on information provided by the seller. The method for uploading information into a database that will be related to the recreational land is generally illustrated in FIG. 1.

The method 20 for generating a database of wildlife information in association with wildlife activities includes the step of collecting input information 22 regarding the wildlife associated activities. The wildlife associated activities may refer to hunting, fishing, or wildlife watching or any type of other wildlife related activities desirable to be performed by outdoor enthusiast. Hunting may refer to any type of animal harvest, such as game animals or trophy game animals taken by an outdoor enthusiasts. Outdoor enthusiast in this application is meant to refer to anyone who participates in wildlife associated activities on recreational land to catch, capture, trap or dispatch wildlife either physically such as through hunting or trapping or virtually such as through viewing, pictures, or videos. As such, capturing may be defined as capturing the animal in the tangible medium other than physically capturing the wildlife, such as in a picture or video recording. In addition, the term “taken or caught” is not just limited to animals that are killed but for certain animals such as fish may refer to those that are caught and released after photographing, recording, or otherwise certifying the physical data of the particular animal or fish.

In the step of collecting input information 22, the input information may broadly include outdoor enthusiast identity data, equipment data, physical animal data, time data, and location data. The outdoor enthusiast who participated in the wildlife associated activities on the recreational land, an e-mail address for the outdoor enthusiast, a phone number for the outdoor enthusiast, or any other desirable information. The equipment data may include the equipment used by the outdoor enthusiast to capture, take, or view the wildlife and any desired information regarding that equipment. For example, if the recreational activity is hunting, the equipment data may list the weapon used to take the trophy game animal, any bait, or attractant used, including the brand of attractant. Equipment data concerning the weapon used to take the trophy game animal may include general classifications such as firearm, rifle, shotgun, trap, or bow. In the case of a firearm, the equipment data may further request the manufacturer, model, and caliber of the weapon and type of ammunition used. Where the wildlife is fish, the equipment data may include tackle, lure, type of line, rod, and reel information. If the animal is not physically captured or trapped, the equipment data may instead refer to the type of spotting scope, power of spotting scope, camera, camera lens, filters, aperture, shutter speed or any other desirable information related to capturing the wildlife in a tangible medium without physically capturing the subject wildlife. More specifically, the equipment data is for a camera, it may include make and model of the camera, ISO or film speed used by the camera, shutter speed, and, if applicable, data regarding the lens and format of the camera, such as brand, focal length and aperture. The equipment data may further include the name of a guide service, lodge, camp, or other facility used.

The system generally includes a database to which the input information collected is uploaded. The input information and any visual recording is typically saved on the database in a machine readable format such that may be electronically accessed, searched and displayed. The database itself may take on a variety of physical forms including, but not limited to, a server or cloud service data storage system or any system in existence or hereinafter invented for storing and searching data.

The physical animal data collected may vary depending on the species of wildlife taken by the outdoor enthusiast. The physical animal data generally identifies species of wildlife, and quantifies size and/or quality characteristics of the wildlife. The time data includes a time at which the wildlife was taken or captured and may specify date, hour, minute, and second information.

The location data includes a location at which the wildlife was taken or captured and may specify state and county information corresponding to the location where the wildlife was taken. The system and method may be set up such that the data may contain information regarding the specific address or GPS coordinates where the wildlife was taken, however, this specific data may not be generally available to the users of the database without further safeguards. For examples, many users of recreational land do not want to share specifically where they obtained wildlife or participate in wildlife associated activities to prevent others from spoiling their desirable spot. However, under certain circumstances, this location data may become visible to the users of the database such as when the underlying recreational land is listed for sale and persons or brokers registered with the site stack-rank the best land for hunting such as deer hunting in a particular county. For example, properties in the database having associated input information or properties within a desirable proximity distance may be tagged for sale and search. Therefore, limits may be set on which the users of the database may see a specific location of recreational land when sorted for wildlife activity. However, the database may also be configured to allow users to sort land that has been tagged for sale by the best hunting land available for sale in a particular county with specific location. Of course, properties could be ranked for any other criteria including bird watching, amount of timber on the land, or anything else desirable to the outdoor enthusiast, including any combination thereof.

The location data may also include property tax rates for the land and topographical, geological, and other information regarding the land cover of the recreational land. For example, the topographical information may include whether the area was forested or a field or more specifically, whether the area was green field, hardwoods, hayfield, ridge, or any other feature of interest. If the land is forested, a certified value of the lumber on the recreational land such as by number of board feet, species, and value of particular trees may be included. The topographical information may further include elevation, proximity to water, natural food sources, slope of the land and any other desired feature. The geological information may include a variety of data including soil and climate conditions. Accordingly, the geological information may be used to indicate whether the land is conducive for growing crops such as corn, soybeans, wheat, etc.

Where the recreational land is adjacent to a water feature or includes a water feature such as a stream or a lake, the topographical information may include information on the water feature. For example, information on the water feature may include water temperature, clarity, weed growth, bottom depth, bottom composition, drop of the stream or river, flow rates of the stream or river and any other information of interest. The location data may also identify portions that are considered wetlands and as such, have limited development potential.

The location data requested may automatically change depending upon the relevant location of the recreational land, and the associated wildlife activity. For example, if the target animal or wildlife of interest is an eagle or is a pheasant, they may have different habitats and as such, different parcels of recreational lands of interest. The location data may also vary in amount of information needed as the system may be configured to pull from existing databases, public records, such as the U.S. Geological Survey and other information on the area. For example, if a person provides the GPS coordinates of a particular recreational land and its approximate boundaries, some of the information may be prefilled in from third party verified sources, simplifying the entry process.

If the recreational land is desired to be leased as hunting land, such as by a landowner who owns the land for forestry reasons such as harvesting timber, they may lease the land to various individuals for recreational activities including a variety of wildlife related activities. As such, land that is known to have a higher recreational value regarding certain activities may bring higher lease rates from certain groups of individuals. Therefore, a landowner may consider as part of the lease criteria for leasing the recreational land an entry of all wildlife activities of interest on the particular parcel of recreational land. As the database grows, the owner of the land may determine that the recreational land has a better use for certain hunting purposes of a particular type of animal. Therefore, as part of determining the recreational value of the land, the method may collect the physical animal data of the wildlife of interest. For example, physical animal data may vary depending upon the type of recreational activity or wildlife activity occurring on the land. If the activity is hunting, fishing, or wildlife watching, substantial differences may occur in the type of physical animal data collected. More specifically, when the desired recreational activity is hunting and the wildlife animal is a deer, the physical animal data may include weight and rack information. The rack information may include the number of points, overall width as measured at the widest segment of the rack, overall height as measured at the tallest segment of the rack and mass of the rack which may include the measured weight of the rack or diameter or circumference of a portion of the rack. Where the wildlife animal is a fish, the physical animal data may include weight and overall length information. Where the wildlife animal is a wild turkey, the physical animal data may include weight, length of beard, and length of spur information. The above examples are just exemplary and a number of other features may be collected as desired and changed for any particular animal.

If the activity is wildlife watching activities, or even for certain hunting activities, if a photo or video recording is desired, the visual recording used may include information to measure or verify the information being submitted. For example, a fish may be certified by viewing a visual recording, showing the fish being weighed on a scale or measured with a ruler.

The overlay data, briefly discussed above with regard to inputting or retrieving sources of information from third parties, may also be used by the database. More specifically, the overlay data may include environmental information based upon time data and location data when the wildlife is spotted or taken. The overlay data may be any data publicly available or available from association with other records in the database that are desirable to the user. The overlay data may include a wide variety of automatically retrieved data which then in turn requires less input information typically from the outdoor enthusiast. Providing the overly data may simplify and shorten the process of data gathering and entry of the outdoor enthusiast. As discussed above, the overlay data may also be entered by third party certifiers such as timber certification companies to determine the amount of useable timber on a particular parcel of recreational land. Other overlay data may include water rights associated with a particular parcel of recreational land. For example, while some parcels may be forested and include harvestable timber as part of the recreational land, others may have open fields or meadows that could be planted with a crop or include grazing lands that are still acceptable for the desired recreational use.

For the data entered by the outdoor enthusiast or third party certifiers, the method also allows ranking of the land. For example, the method may allow ranking of the land based upon third party certified hardwood timber with a subsequent ranking based upon a particular species of interest or a particular recreational activity. The method of ranking may further account for the difference in property tax rates associated with the land. The ranking module is expected to have executable instructions for ranking wildlife animal entries as well as land entries stored in the database by comparing at least one portion of the data related to the recreational land to other recreational land parcels. Accordingly, the ranking module may generate a list of ranked recreational land. The list of ranked recreational land may be generally arranged so that the most physically impressive or desirable features appear first. Of course, these features may vary depending upon the outdoor enthusiast's or end user's desired criteria. For example, a bird watcher for rare birds may be interested in owning recreational land that produces income such as through grazing or timber harvesting but also use the present invention to determine, even though there is no data for that parcel, that in that surrounding areas, other parcels of recreational land have sightings of desirable birds. Similarly, the database may provide expected ground cover from multiple sources. An outdoor enthusiasts interested in hunting may find a parcel of recreational land that provides economic value but is also likely to have the desired characteristics based upon entries for parcels of recreational land surrounding the desired parcel. The ranking module may rank each piece of land through any desirable criteria from the number of animals taken on a particular parcel to the size of wildlife animals taken on a particular parcel or surrounding parcel to the rare types of wildlife seen on a particular parcel. The ranking module may additionally account for the property tax rates among the ranked parcels such that the outdoor enthusiast can determine the most desirable parcel considering both recreational appeal and cost of ownership.

The present method may also be used to determine the likelihood or value of certain wildlife related activities. As such, a landowner may easily determine the highest and best use for recreational activity. This allows a landowner to maximize the economic value of a particular parcel of recreational land beyond typical grazing and timber rights.

The ranking platform may also include an output module having executable instructions for outputting the wildlife animal entries in the list of ranked wildlife animal entries to a social media user interface or other interface accessible by end users. The user interface provides an interface allowing users to access and search the database as well as upload entries to the database. It should be appreciated that by accessing the database, the user can view all of the recreational land entries uploaded to the database by the user or other users. It should also be appreciated that when the user uploads a recreational land entry to the database or a wildlife animal to the database or other wildlife related activities to the database, the entry is permanently saved on the database and that all or a portion of the entry may become accessible to other users. In some instances, such as regarding the particular location of land, the actual location may be slightly obscured such that a person entering their prime hunting land is not overrun by others in the future. Of course, when the parcel of recreational land is listed for sale, all data relating to that particular parcel such as particular animals captured, taken or seen on the parcel or available timber harvest may be available for viewing or limited viewing as desired since typically upon the sale of the land, people using the land for recreational activities need to negotiate new access rights with the new owners. The data relating to the particular parcel may further include property tax rates and estimated values of the timber and prospective crop capacity for the particular parcel.

The ranking interface may take a variety of forms including but not limited to a webpage or a software application. Users can run the webpage or software application on a variety of user devices such as but not limited to personal computers, laptops, pocket organizer devices, e-reader devices, cell phone devices, smart phone devices, and tablet devices. These devices generally may have a display screen for displaying graphics and input means for entering information and selecting the graphics displayed on the display screen.

The ranking interface may include a user home page. The user home page may present the list of ranked animal entries for wildlife activities or the ranked land based on the desired wildlife activities. The list of ranked recreational land may display a visual recording and at least a portion of the input information for each of the trophy animal entries presented associated with the recreational land. The user home page may also display multiple lists of ranked recreational land ranked according to different ranking schemes. For example, the user home page may display lists of ranked recreational land entries for the top five deer taken in Alabama over the last year on the land or in close proximity to the land. The user home page may also display news flashes which may include outdoor related articles or single trophy animal entries. For example, the news flashes may show single trophy animal entries selected as first kills, first catches, or top for today in close proximity to a desired geographic area. Alternatively, the news flashes may show property listings that have recently been listed for sale on the database. These news flashes and lists of ranked trophy animal entries or ranked recreational land may be refreshed in predetermined time intervals and may be continuously updated to provide accurate rankings and information in real time.

The user home page may also include a search feature allowing users to enter a search query. The search query may be for a particular geographic area or for a particular list of ranked recreational land for a specified activity and specified wildlife. Accordingly, the user can search for desirable recreational land by a particular activity, species, or any other specific data that the ranking module will use to produce a particular list of ranked recreational land. The user home page may additionally include ad banners, navigational tools, and links presented as selectable graphics allowing users to navigate to various other pages of the ranking platform.

The executable instructions of the output module may include a variety of steps for establishing communication between the database and the user device. Communication between the database and the user device may take a wide variety of forms and may utilize a wide variety technologies and physical infrastructure. For example, the executable instructions of the output module may establish wired or wireless communication between the database and the user device via the internet. In the case of a mobile user device, wireless communication may be established via a wireless network such as WIFI or by a wide area service network such as WAN, 3G, or 4G wireless data services. In addition to establishing communication between the database and the user device, the executable instructions of the output module may include a variety of steps including outputting information, sending requests for information, and sending various operational commands between the database and the user device to operate the ranking platform.

The ranking platform may include a memory module. The memory module may store a variety of information including user preference information. The user preference information may include data concerning the user's use of the ranking platform including a viewing history of information accessed by the user and a search history of the search queries entered by the user. Accordingly, the ranking platform may tailor the lists of ranked property listings and other information presented on the user home page based upon the user identity data and the user preference information. For example, where a user lives in Texas and has searched for deer hunting properties located in Texas and Louisiana in the past month, the user home page for that user may include lists of the top ten and geographic areas for taking deer in Texas and in Louisiana in the past month as well as a current listing of land parcels for sale in those areas. In this way, the ranking platform tailors the user home page to fit the interests of each user, and also allows a user to find desirable recreational land.

The ranking interface may further include a user trophy room for each parcel of recreational land in the ranking platform. The trophy room of a parcel of recreational land may be populated with and present all of the trophy animal entries related to the recreational land parcel or the geographic area of the recreational land parcel over a pre-determined period of time. For example, the trophy room for an exemplary parcel of recreational land may include all trophy animal entries ever uploaded for that parcel or only those uploaded during the past ten years. It should be appreciated that the trophy animal entries presented in the trophy room may include trophy animals from a wide variety of species and as such, the trophy room may additionally include a plurality of trophy walls.

Each trophy wall may include a portion of the trophy animal entries selected based upon certain criteria. For example, the trophy room may include a trophy wall for all trophy animal entries uploaded in a given time period such as in a given year. Alternatively, the user trophy room may include a trophy wall for all trophy animal entries uploaded by the user for a certain species or category of animal. For example, if the recreational land borders water, it may have a trophy wall for all fish species and another trophy wall for all mammal species. It should be appreciated that the criteria for selecting the trophy animal entries for the trophy walls may be automatically provided by the ranking platform as default settings or may be customized by the user.

Each of the trophy animal entries presented in the trophy room for a parcel of recreational land may display the visual recording of each trophy animal or wildlife uploaded and at least a portion of the input information associated with that entry. By selecting a particular animal entry, additional information may be displayed. For example, more of the input information may be presented as well as the overlay data associated with the wildlife entry in response to selection of the particular entry. The user trophy room may further include a comment section where other users can provide written comments.

It should be appreciated that the trophy room and the trophy walls are virtual elements of the ranking interface and are not meant to necessarily correspond with any structure or limitations commonly associated with the rooms and walls of a physical building. Also, the trophy room and the trophy walls may be accessed by users in a variety of ways. A user may access the trophy room of a particular parcel of recreational land or a particular geographic area, including a variety of parcels of recreational land by entering a search query for the particular user using the search feature of the user home page. Alternatively, a user may access the trophy room of a particular geographic area or parcel of recreational land by selecting the desirable criteria. Accordingly, the trophy room feature allows a prospective purchaser to view all of the game animals previously harvested on a particular parcel of land. This may aid a prospective purchaser in predicting future performance of the recreational land for their purposes.

The ranking module of the ranking platform may also have executable instructions for ranking the trophy rooms of a plurality of parcels of recreational land to generate a list of ranked recreational land. The executable instructions may rank the trophy rooms based on any number of desirable criteria such as the number of trophy animal entries presented in the trophy rooms or the number of different species of trophy animals presented in the trophy rooms. Accordingly, the trophy room may be ranked and compared to other trophy rooms based on the total number of trophy animal entries or wildlife entries presented in the trophy room. It should be noted that the term trophy animal may refer to any wildlife and as such, trophy animal may be substituted with wildlife. Alternatively, the ranking may be based on the number of or variety of wildlife entries presented in the trophy room. For example, trophy rooms may be ranked based on the number of trophy deer entries presented. The trophy rooms may also be ranked based on the number of different species of animal accounted for by trophy animal entries presented in the trophy room. For example, trophy rooms may be ranked based on the number of different waterfowl species represented by the trophy animal entries presented in the trophy room. In this manner, a parcel of recreational land may be identified for the variety of trophy animals presented in their trophy room.

It should be appreciated that the ranking platform caters not only to hunters and fisherman but also to bird watchers and naturalists. The trophy animal entries need not correspond to wildlife or animals killed or caught but could also include wildlife or animals sighted or photographed. In accordance with the ranking platform presented above, these sightings can be recorded as entries in the database. Input information can be entered and overlay data can be retrieved. Accordingly, the social media interface functions in much the same way. The ranking module can then rank the trophy rooms to generate a list of ranked trophy rooms. The trophy rooms may be ranked based on any number of desirable criteria such as the number of entries, size of the entries presented in the trophy rooms or the number of different species presented in the trophy rooms. For example, the trophy rooms of bird watchers may be ranked based on the number of different bird species represented by the animal entries presented in the trophy rooms. Accordingly, a parcel of recreational land may be recognized for the uploading a diverse number of bird species sightings to the database as wildlife entries by various users.

Obviously, many modifications and variations of the present invention are possible in light of the above teachings and may be practiced otherwise than as specifically described while within the scope of the appended claims. Although the steps of the method set forth herein are presented in a particular order, many variations in the order of the steps are possible. Accordingly, the present invention is not limited to the particular order of the method steps presented herein.

What is claimed is:

1. A method of displaying and ranking recreational land comprising:
collecting input information regarding wildlife associated activities and wherein the collected input information includes location data;
uploading the collected input information into a database; and
ranking parcels of land using the collected input information.

2. The method of claim 1 wherein said step of collecting input information regarding wildlife associated activities further includes at least one type of wildlife associated activity and a time input related to the wildlife associated activity.

3. The method of claim 2 wherein said at least one type of wildlife associated activity includes at least one of hunting, fishing, and wildlife watching.

4. The method of claim 2 wherein said step of collecting input information regarding wildlife associated activities further includes at least one of equipment data, physical animal data, and outdoor enthusiast identity data.

5. The method of claim 4 wherein said at least one of equipment data, physical animal data, and outdoor enthusiast identity data is equipment data and wherein said equipment data collected is dependent on the type of wildlife associated activity.

6. The method of claim 5 wherein said type of wildlife activity is hunting and said equipment data includes at least one of the general classification of the weapon, manufacturer, model, caliber, type of ammunition, type of bait and type of attractant.

7. The method of claim 5 wherein the wildlife associated activity is fishing and the equipment data includes at least one of type of tackle, bait, lure, line, rod, and reel information.

8. The method of claim 5 wherein the wildlife associated activity is wildlife watching and the equipment data includes at least one of type of spotting scope, type of camera, power of spotting scope, camera lens, filters, aperture, shutter speed, manufacturer of the equipment, model of equipment, ISO, and focal length.

9. The method of claim 5 wherein the equipment data includes at least one of name of guide service, name of lodge, name of camp, and name of facility used.

10. The method of claim 4 wherein said at least one of equipment data, physical animal data, and outdoor enthusiast identity data is physical animal data and wherein said physical animal data collected is dependent on the type of wildlife associated activity.

11. The method of claim 10 wherein the physical animal data includes species of wildlife, and at least one of a size characteristic of wildlife and a quality characteristic of wildlife.

12. The method of claim 2 wherein the time input includes at least one of year, month, hour, and minute at which wildlife was taken during a wildlife associated activity.

13. The method of claim 1 wherein location data includes at least one of address, GPS coordinates, and county and state.

14. The method of claim 1 further including the step of displaying a ranked parcel of recreational land.

15. The method of claim 14 wherein said location data is not visible to users of the database until the recreational land is listed for sale.

16. The method of claim 14 wherein ranked parcels of recreational land within a certain proximity distance are displayed in relation to specified wildlife associated activities.

17. The method of claim 1 wherein said location data includes at least one of property tax rates for the land, topographical information and geological information.

18. The method of claim 17 wherein said location data includes topographical information and the topographical information includes information regarding at least one of land cover, value of lumber, species of trees, proximity to water, natural food sources, slope of land, and elevation.

19. The method of claim 17 wherein said location data includes geological information including soil and climate conditions.

20. The method of claim 1 wherein said location data includes information regarding proximate water features including at least one of type of water feature, water rights, clarity, weed growth, bottom depth, bottom composition, drop of stream or river, flow rates of stream or river and wetland features.

21. The method of claim 20 wherein said type of water feature is selected from at least one of stream, river, and lake.

22. The method of claim 1 further including the step of changing the location data requested depending on the type of associated wildlife activity.

23. The method of claim 1 further including the step of obtaining additional location information from verified third party sources and public records.

24. The method of claim 23 further including the step of prefilling certain location information during said step of collecting input information.

25. The method of claim 1 wherein said step of ranking includes the step of ranking the recreational land based on at least one of lumber value, recreational value, physical animal data, and recreation activity.

26. The method of claim 1 wherein said step of collecting input information includes the step of certifying the information.

27. The method of claim 26 wherein said step of certifying the information includes the step of obtaining a visual recording.

28. The method of claim 1 wherein said step of collecting the input information includes the step of data entering by a third party certifier.

29. The method of claim 1 wherein said step of ranking further includes the step of generating a list of ranked recreational land.

30. The method of claim 29 wherein said step of generating a list of ranked recreational land includes the step of comparing entries stored in the database for at least one portion of the data related to the recreational land to other recreational land parcels.

31. The method of claim 1 wherein said step of ranking includes the step of ranking through selected criteria including at least one of a number of animals taken on a particular parcel of land, size of wildlife animals on a particular parcel of land, size of animals taken on a surrounding parcels, rare types of wildlife, property tax rates, and economic value of the parcel or surrounding parcels.

32. The method of claim 1 further including the step of determining the likelihood of selected wildlife related activities for a parcel of recreational land.

33. The method of claim 1 further including the step of displaying multiple lists of ranked recreational land according to different ranking schemes.

34. The method of claim 1 further including the steps of receiving a search query from a user and displaying a list of ranked recreational land.

35. The method of claim 34 wherein the search query is at least one of geographic area, specified activity and specified wildlife.

36. The method of claim 1 further including the step of displaying a trophy room for each parcel of recreational land.

37. The method of claim 36 wherein the trophy room is populated with all trophy animal entries related to the recreational land parcel in a specified period of time.

38. The method of claim 36 wherein the trophy room is populated with all trophy animal entries within a geographic area of the recreational land parcel in a specified period of time.

39. The method of claim 36 wherein said step of ranking is based on the ranking of the trophy rooms to generate a list of ranked recreational land.

40. The method of claim 1 further including the step of inputting into the database of parcels of land.

41. The method of claim 40 further including the step of ranking the recreational land based on animals on the recreational land.

42. The method of claim 1 further including the step of ranking the recreational land based on resources available on the recreational land.
